(19) United States
(12) Patent Application Publication
(10) Pub. No.: US 2024/0330789 A1
(43) Pub. Date: Oct. 3, 2024

(54) ROUTE OPTIMIZATION FOR VENDOR IN STADIUM

(71) Applicant: Rakuten Group, Inc., Tokyo (JP)

(72) Inventors: Haruka HORIUCHI, Tokyo (JP); Saki TANAKA, Tokyo (JP); Keisuke TAKAMI, Tokyo (JP)

(73) Assignee: Rakuten Group, Inc., Tokyo (JP)

(21) Appl. No.: 18/616,417

(22) Filed: Mar. 26, 2024

(30) Foreign Application Priority Data
Mar. 30, 2023 (JP) 2023-054453

(51) Int. Cl. G06Q 10/047; G06Q 30/0202

(52) U.S. Cl. CPC G06Q 10/047; G06Q 30/0202

(57) ABSTRACT

According to an aspect of the present invention, there is provided a route determination apparatus that has one or more processors that execute a process including: collecting preference information relating to preferences of spectators at an event held at a facility; calculating, from the collected preference information, a demand level for a vendor of products in each seating block in the facility; determining, on the basis of the demand level in each seating block, a route along which the vendor is to move; and adjusting the route such that a position of the vendor moving along the determined route satisfies a predetermined condition.

### TECHNICAL FIELD

The present disclosure relates to route optimization for a vendor in a stadium. Priority is claimed on Japanese Patent Application No. 2023-054453, filed on Mar. 30, 2023, the content of which is incorporated herein by reference.

### BACKGROUND

At large-scale facilities such as stadiums where events such as sports matches take place, mobile sales for selling products such as food and drinks are provided to spectators watching the event. Vendors performing the mobile sales move among spectator seating while carrying a drinks server, for example, and sell drinks in response to requests from spectators.

### CITATION LIST

### Patent Literature

Patent Document 1: JP 2021-144704 A
Patent Document 2: JP 2018-142080 A

### SUMMARY OF INVENTION

### Technical Problem

However, the current situation is that routes along which vendors move when selling products are determined on the basis of the experience of each individual, or the like, and there are cases in which, depending on the route, spectators lose opportunities to purchase products and vendors lose opportunities to sell products.

The present disclosure was devised in the light of the foregoing and has an objective of providing route optimization for a vendor in a stadium by which opportunity loss for product purchases and product sales can be suppressed.

### Solution to Problem

According to one embodiment of the present disclosures, a route determination apparatus has one or more processors that execute a process including: collecting preference information relating to preferences of spectators at an event held at a facility; calculating, from the collected preference information, a demand level for a vendor of products in each seating block in the facility; determining, on the basis of the demand level in each seating block, a route along which the vendor is to move; and adjusting the route such that a position of the vendor moving along the determined route satisfies a predetermined condition.

Further, according to another embodiment of the present disclosure, a route determination method includes: collecting preference information relating to preferences of spectators at an event held at a facility; calculating, from the collected preference information, a demand level for a vendor of products in each seating block in the facility; determining, on the basis of the demand level for each seating block, a route along which the vendor is to move; and adjusting the route such that a position of the vendor moving along the determined route satisfies a predetermined condition.

### BRIEF DESCRIPTION OF DRAWINGS

FIG. 1 illustrates an example of a communication system according to one embodiment.

FIG. 2 is a block diagram illustrating the configuration of a route determination apparatus according to one embodiment.

FIG. 3 illustrates a specific example of spectator information.

FIG. 4 is a flow diagram illustrating a route determination method according to one embodiment.

FIG. 5 illustrates a specific example of a demand level map.

FIG. 6 illustrates a specific example of the route.

FIG. 7 is a block diagram illustrating an example of a hardware configuration of the route determination apparatus.

### DESCRIPTION OF EMBODIMENTS

Below, an embodiment according to the present disclosure will be described with reference to the attached drawings. The embodiment described below is exemplary and the present disclosure is not to be construed as being limited by this description.

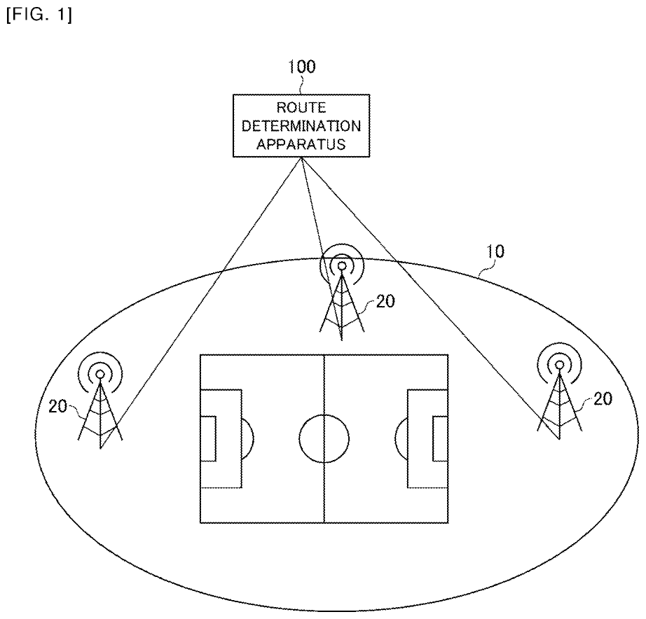

FIG. 1 illustrates an example of a communication system according to one embodiment. The communication system shown in FIG. 1 is, for example, formed in a stadium 10 at which an event such as a sports game takes place, and has a plurality of base stations 20 which are installed inside the stadium 10. A route determination apparatus 100 is connected to the plurality of base stations 20.

The stadium 10 is a facility capable of holding an event such as a sports game that is watched by spectators. The stadium 10 has, for example, a field on which a soccer match or an athletics competition (hereinafter, referred to collectively as “game”) is held, and spectator seating for spectators to watch the game. Mobile sales in which a vendor sells products such as food and drinks are carried out in the spectator seating. That is, while carrying a drinks server, or the like, and moving along aisles in the spectator seating, for example, a vendor sells drinks to spectators that wish to make a purchase. At that time, as described later, the vendor moves along aisles in the spectator seating in accordance with a route notified from the route determination apparatus 100.

The base stations 20 are installed inside the stadium 10 and execute wireless communication with terminal apparatuses inside the stadium 10. Specifically, the base stations 20 execute wireless communication with, for example, terminal apparatuses such as smart phones that the spectators and vendors hold, or wearable terminals such as smart glasses that the vendors wear. Further, the base stations 20 forward data wirelessly received from the terminal apparatuses inside the stadium 10 to the route determination apparatus 100, and also wirelessly transmit data received from the route determination apparatus 100 to the terminal apparatuses inside the stadium 10.

The route determination apparatus 100 determines a route along which a vendor performing mobile sales is to move when selling products. At that time, the route determination apparatus 100 calculates a demand level for each vendor for each block of seats in the spectator seating, and determines a route for each vendor such that a vendor moves with priority in a block having a high demand level. Further, in order to suppress occurrences of communication congestion in cells formed by the base stations 20, the route determination apparatus 100 adjusts routes to prevent vendors from becoming concentrated in a specific cell. The specific configuration and operations of the route determination apparatus 100 are explained in detail later.

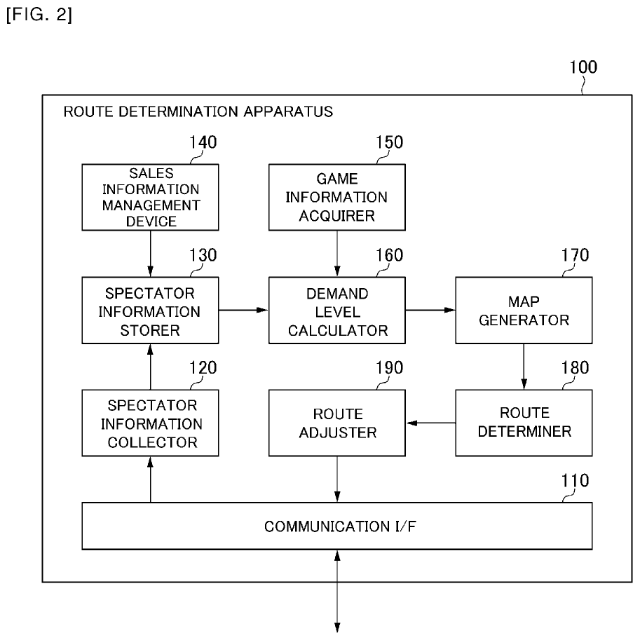

FIG. 2 is a block diagram illustrating the configuration of a route determination apparatus 100 according to one embodiment. The route determination apparatus 100 shown in FIG. 2 has a communication interface (hereinafter abbreviated to “communication I/F”) 110, a spectator information collector 120, a spectator information storer 130, a sales information management device 140, a game information acquirer 150, a demand level calculator 160, a map generator 170, a route determiner 180, and a route adjuster 190.

The communication I/F 110 is an interface that communicates with the base stations 20 inside the stadium 10. The communication I/F 110 receives, via the base stations 20, spectator information relating to spectators in each seat from terminal apparatuses that the spectators hold, and transmits, via the base stations 20, route information relating to vendor routes to the terminal apparatuses that the vendors hold. The communication I/F 110 may communicate not only with the base stations 20 inside the stadium 10, but also with a network outside the stadium 10.

The spectator information collector 120 collects spectator information relating to spectators from terminal apparatuses that the spectators hold. Specifically, when a spectator inputs information relating to a personal preference of that spectator to a terminal apparatus, the spectator information collector 120 collects the inputted information. That is, when, for example, a spectator inputs preference information such as a preferred brand of drink or a preferred vendor via an application that operates in a terminal apparatus, the spectator information collector 120 collects the preference information that the spectator inputted. Other than a brand and a vendor, the spectator information collector 120 may also collect, for example, preference information such as a player or team that the spectator supports. Note that the spectator information collector 120 does not necessarily have to collect spectator information from a spectator inside the stadium 10 and may collect spectator information before a spectator arrives at the stadium 10 via a network outside the stadium 10.

The spectator information storer 130 stores spectator information collected from spectators by the spectator information collector 120. At that time, when storing the spectator information, the spectator information storer 130 associates spectator information relating to spectators to whom seats have been allocated with respective seats of the spectator seating in the stadium 10. Further, the spectator information storer 130 stores purchase histories including products that spectators purchased inside the stadium 10 and purchase times thereof, and associates the purchase histories with spectators in the respective seats.

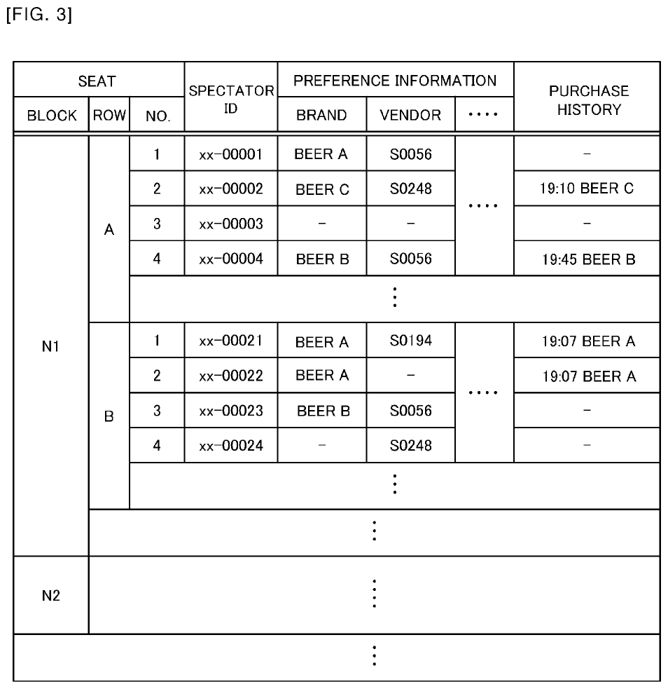

A specific example of spectator information that the spectator information storer 130 stores is shown in FIG. 3. As illustrated in FIG. 3, the spectator information storer 130 stores identification information (spectator ID) of spectators to whom seats have been allocated as well as spectator preference information and purchase histories, and associates the foregoing with respective seats in the stadium 10.

The spectator seating of the stadium 10 has a plurality of blocks that are partitioned by aisles, and each block includes a plurality of seats that are identified by a row and number. For example, a spectator that was allocated a respective seat by a ticket is allocated a spectator ID that uniquely identifies the spectator, and the spectator information storer 130 associates a seat identified by a block, row, and number with the spectator ID of the spectator to whom that seat was allocated. Further, the spectator information storer 130 associates and stores preference information collected from spectators with the spectator in the respective seat, acquires spectator product purchase histories from the sales information management device 140 and associates and stores the spectator product purchase histories with the spectator in the respective seat.

In the example shown in FIG. 3, a spectator to whom a seat at block N1, row A, number 1 was allocated is, for example, allocated a spectator ID “xx-00001”, and for this spectator, it is stored that “beer A” is the preferred brand and that a vendor with identification information “S0056” is the preferred vendor. Further, since the spectator has not yet purchased any products inside the stadium 10, the purchase history is blank. Similarly, a spectator to whom a seat at block N1, row B, number 1 was allocated is, for example, allocated a spectator ID “xx-00021”, and for this spectator, it is stored that “beer A” is the preferred brand and that a vendor with identification information “S0194” is the preferred vendor. Further, since the spectator has already purchased a product inside the stadium 10, a purchase history “purchased beer A at 19:07”, which includes a purchased product and purchase time, is stored.

Returning to FIG. 2, the sales information management device 140 manages a sales state of products sold inside the stadium 10. That is, when a product is purchased by a spectator, the sales information management device 140 associates the purchased product with the seat allocated to that spectator, and stores the information. At that time, the sales information management device 140 may, for example, acquire, from a terminal apparatus which is carried by a vendor and used for payment, sales information including a spectator seat and purchased product. The sales information management device 140 stores purchase histories of spectators in each seat in the spectator information storer 130.

The game information acquirer 150 acquires information about a game taking place on the field of the stadium 10. Specifically, the game information acquirer 150 acquires, for example, information such as a score in a soccer game, standings in an athletics competition, and the like, or information relating to a player or team that is winning or losing.

The demand level calculator 160 calculates, on the basis of the spectator information stored by the spectator information storer 130 and the game information acquired by the game information acquirer 150, a demand level indicating a size of a demand for a vendor for each block of the spectator seating.

Specifically, the demand level calculator 160 quantifies a size of a demand for a respective vendor by aggregating, in block units of the spectator seating, spectator preference information and purchase histories. That is, a numerical value indicating a large demand is, for example, allocated to a vendor selling a brand which is preferred by spectators in a block or to a vendor that is the preferred vendor in a block. Further, there is allocated a numerical value which, for example, indicates that the longer is an elapsed time since a previous purchase by a spectator in a block, the larger is the demand in that block.

Furthermore, on the basis of the game information, the demand level calculator 160 may apply a weight to the size of a demand in each block of the spectator seating. That is, in a case in which allocated seats differ according to a team that is supported, for example, a weight may be applied such that demand becomes larger in a block of the spectator seating in which a winning team is supported.

In such a manner, the demand level calculator 160 calculates a demand level indicating a size of a demand for a respective vendor for each block of the spectator seating. In other words, the demand level calculator 160 calculates one value as a demand level for each vendor and each block of the spectator seating.

The map generator 170 generates a demand level map indicating a distribution of the demand levels calculated by the demand level calculator 160. Specifically, the map generator 170 generates, for each vendor, a demand level map indicating a demand level for each block of the spectator seating. According to the demand level map, a distribution of blocks having a large demand for a vendor inside the stadium 10 is easily identifiable.

The route determiner 180 determines, on the basis of the demand level map generated by the map generator 170, a route for a vendor when performing mobile sales. Specifically, the route determiner 180 determines a route in which a vendor moves with priority in a block of the spectator seating having a large demand in the demand level map. That is, the route determiner 180 determines a route for a vendor so that the vendor moves along an aisle adjacent to a block having a large demand for that vendor. Accordingly, the route determiner 180 determines a route for each vendor on the basis of the demand level map of each vendor.

The route adjuster 190 adjusts the determined route for each vendor. That is, the route adjuster 190 adjusts the route of each vendor such that when each vendor moves in accordance with a respective route, a plurality of vendors do not become concentrated in the same cell. The route adjuster 190 identifies, from position information of cells formed by the base stations 20, for example, cells through which the routes of each vendor pass, and determines whether or not there is a cell in which a predetermined number of vendors or more are present at the same time. In addition, when there is a cell in which a predetermined number of vendors or more are present, the route adjuster 190 changes the routes of these vendors so that the number of vendors present in the same cell at the same time becomes less than the predetermined number.

Due to the route adjuster 190 adjusting the routes in such a manner, it is possible to prevent the occurrence of congestion in base stations 20 caused by vendor communication. Note that an exclusive network slice may be allocated to vendor communication. In that case, by adjusting the routes of each vendor so that a plurality of vendors do not become concentrated in the same cell, it is possible to prevent a resource shortage in the exclusive network slice.

The route adjuster 190 transmits route information relating to the adjusted routes of each vendor from the communication I/F 110 to terminal apparatuses that the respective vendors hold. The route information may be transmitted to a terminal apparatus such as a smart phone that a vendor holds or may be transmitted to a wearable terminal such as smart glasses that a vendor wears. Due thereto, a vendor can visually confirm his or her own route information and move along an efficient route while selling products.

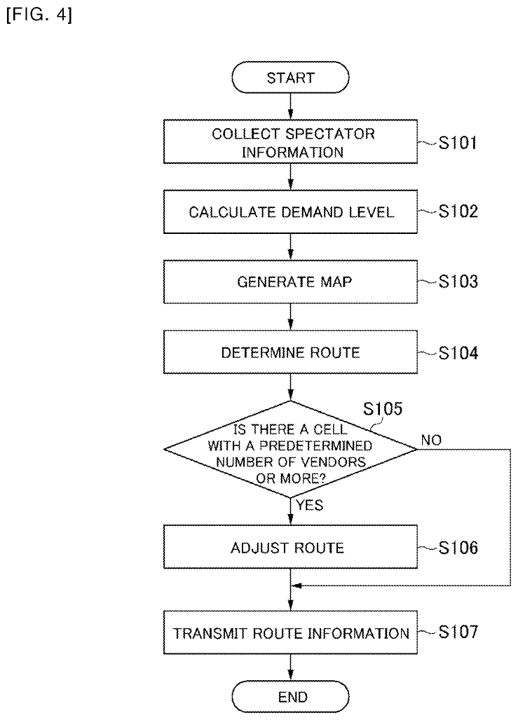

Next, a route determination method using the route determination apparatus 100 configured as described above shall be explained with reference to the flow diagram shown in FIG. 4.

A spectator watching a game in the stadium 10, for example, inputs preference information such as a preferred brand of drink or a preferred vendor via an application that operates in a terminal apparatus that that spectator holds. That is, when a list of brands of products sold in a stadium 10 or vendors selling the products is displayed on the terminal apparatus, the spectator selects a preferred brand or vendor from the displayed list. Spectator information including the preference information inputted into the terminal apparatus by the spectator is collected by the spectator information collector 120 of the route determination apparatus 100 (step S101).

The collected spectator information is stored by the spectator information storer 130. Specifically, spectator information relating to spectators to whom seats have been allocated is associated with a respective seat of the spectator seating in the stadium 10 and stored. Further, when a spectator purchases a product inside the stadium 10, by acquiring sales information from the sales information management device 140, purchase histories including purchased products and purchase times are associated with spectators in the respective seats and stored.

In addition, at a predetermined timing for determining vendor routes, demand levels for respective vendors for each block of the spectator seating are calculated by the demand level calculator 160 on the basis of the spectator information stored by the spectator information storer 130 and the game information acquired by the game information acquirer 150 (step S102).

Specifically, spectator preference information and purchase histories are aggregated in block units of the spectator seating, and the size of a demand for a vendor in each block is quantified. That is, the more spectators there are in a block that prefer a brand of a product sold by a vendor, for example, the larger is the demand level for that vendor in that block, and the more spectators there are in a block that prefer a vendor, for example, the larger is the demand level for that vendor in that block. Further, the longer is an elapsed time since a previous purchase by a spectator in a block, for example, the lager is the overall demand level in that block for all vendors. Furthermore, a weight may be applied such that, for example, on the basis of the game information, the overall demand for all vendors becomes larger in a block of the spectator seating in which a team that is winning is supported.

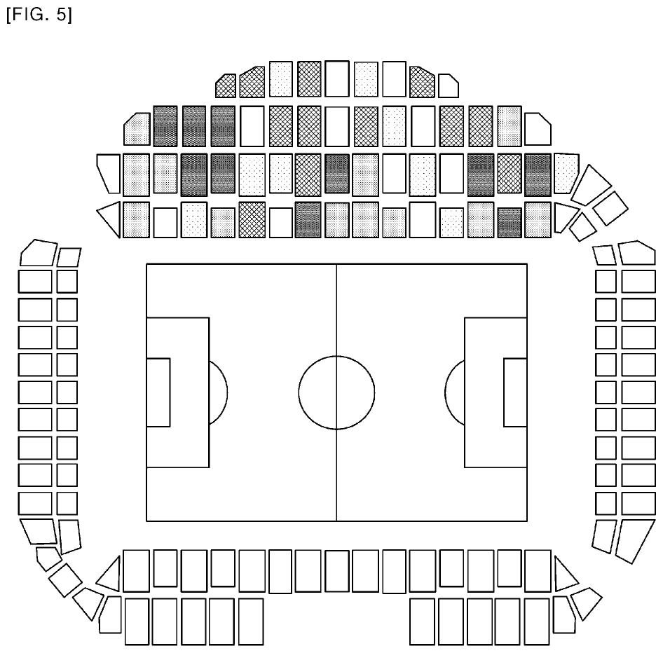

By calculating, for each block, a demand level for respective vendors in such a manner, a demand level map indicating a distribution of demand levels for vendors is generated by the map generator 170 (step S103). Specifically, as shown in FIG. 5, for example, a demand level map indicating a demand level for a vendor in each block of the spectator seating is generated. In the demand level map shown in FIG. 5, shading is used to show the size of a demand level in each block for a portion of the spectator seating in the stadium 10. Here, a block with a darker color closer to black is deemed to have a larger vendor demand level. Such demand level maps are generated for each vendor, and by using the demand level map of a respective vendor, it becomes possible to easily identify a distribution of blocks having a large demand for the vendor.

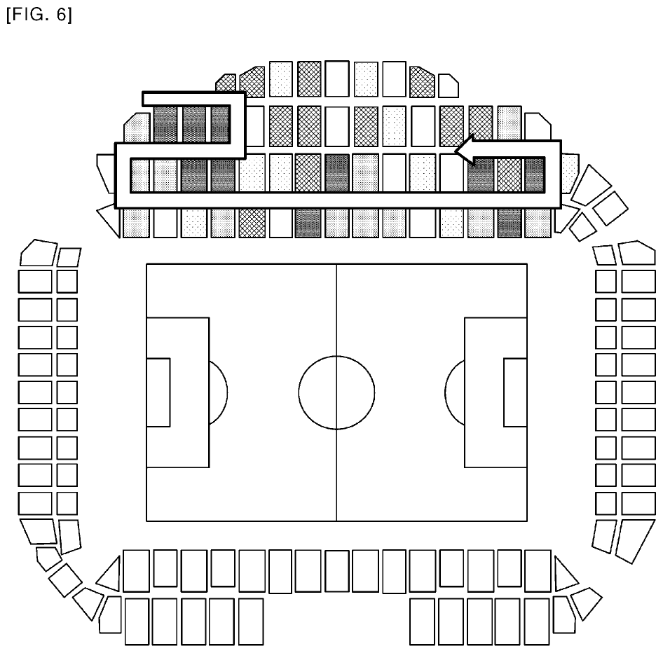

When demand level maps for each vendor are generated, the route determiner 180 determines, from a demand level map of a respective vendor, a route along which the vendor is to move (step S104). Specifically, as shown by the white arrow in FIG. 6, for example, a route for moving with priority in aisles adjacent to blocks having a large demand level for a vendor is determined. That is, in the demand level maps of respective vendors, a route is determined for each vendor such that the vendor passes close to blocks with a dark color.

When routes for all vendors are determined from the demand level map of the respective vendor, the route adjuster 190 refers to the routes of each vendor and position information of cells formed by the base stations 20 in the stadium 10 and determines whether or not there is a cell in which a predetermined number of vendors or more are present at the same time (step S105). That is, while each vendor moves along a route, it is determined whether or not a predetermined number of vendors or more will enter the same cell. When the result of the determination is that there is a cell in which a predetermined number of vendors or more are present at the same time (step S105 YES), the route adjuster 190 adjusts the routes of the vendors such that the number of vendors present in the same cell at the same time becomes less than the predetermined number (step S106). Due thereto, when each vendor moves along a route, the number of vendors present in a cell becomes less than the predetermined number, and it is possible to prevent the occurrence of communication congestion in the base stations 20.

In addition, when there are no cells in which a predetermined number of vendors or more are present at the same time (step S105 NO), route information relating to the routes of each vendor is transmitted to terminal apparatuses that each vendor holds (step S107). The route information is displayed on a terminal apparatus such as smart glasses or a smart phone that a vendor holds, and by confirming the route information, the vendor can move along an efficient route while selling products.

As described above, according to the present embodiment, demand levels for vendors in each block of the spectator seating are calculated, routes in which the vendors move with priority in blocks having a large demand level are determined, and the routes of each vendor are adjusted such that a predetermined number of vendors or more are not present in the same cell at the same time. Due thereto, vendors can sell products while moving along routes which have a large demand for products and in which communication congestion does not occur, and thus, it is possible to suppress opportunity loss for purchasing products and selling products.

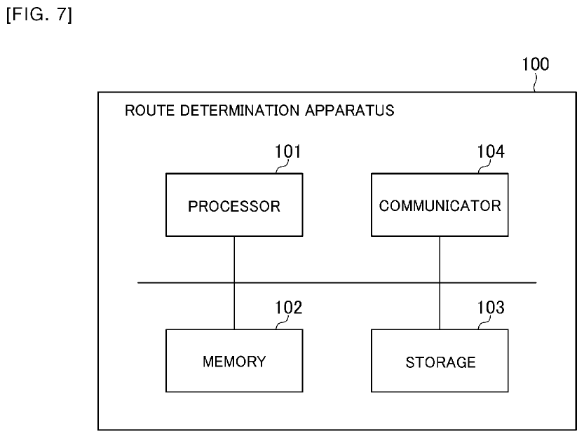

The route determination apparatus 100 according to the embodiment described above may be configured by using a processor and a memory. FIG. 7 is a block diagram illustrating an example of a hardware configuration of the route determination apparatus 100 according to one embodiment. As shown in FIG. 7, the route determination apparatus 100 has a processor 101, a memory 102, a storage 103, and a communicator 104.

The processor 101 includes, for example, a Central Processing Unit (CPU), a Field Programmable Gate Array (FPGA), a Digital Signal Processor (DSP), or the like, and performs integrated control of the entire route determination apparatus 100 as well as executing various kinds of information processing.

The memory 102 includes, for example, a Random Access Memory (RAM), a Read Only Memory (ROM), or the like, and stores information used in information processing executed by the processor 101.

The storage 103 includes, for example, a Hard Disk Drive (HDD), a Solid State Drive (SSD), or the like, and stores various kinds of data.

The communicator 104 includes an interface for executing wired communication or wireless communication, and communicates with the base stations 20, and the like, inside the stadium 10.

Note that the route determination apparatus 100 may, for example, have other configurations not shown, such as a display, an operation switch, or the like.

The process performed by the route determination apparatus 100 explained in the embodiment above may also be described as programs that can be executed by a computer. In that case, these programs can be stored on a computer-readable non-transitory recording medium and installed onto a computer. Examples of such a recording medium include portable recording media such as CD-ROMs, DVD discs, USB memories, and the like, and semiconductor memories such as flash memories, and the like.

Note that the present disclosure is not limited to the above embodiment and includes various modified examples in which constituent elements have been added, removed, or replaced with respect to the configurations described above.

The present disclosure described above includes the following (1) to (7).

(1) A route determination apparatus having one or more processors that execute a process comprising:
collecting preference information relating to preferences of spectators at an event held at a facility;
calculating, from the collected preference information, a demand level for a vendor of products in each seating block in the facility;
determining, on the basis of the demand level in each seating block, a route along which the vendor is to move; and
adjusting the route such that a position of the vendor moving along the determined route satisfies a predetermined condition.

(2) The route determination apparatus described in (1) above,

wherein the collecting includes
collecting information regarding a brand of a product that a spectator selects from among products sold in the facility.

(3) The route determination apparatus described in (1) above,

wherein the collecting includes
collecting information regarding a vendor that a spectator selects from among vendors selling products in the facility.

(4) The route determination apparatus described in any one of (1) to (3) above,

wherein the calculating includes
calculating the demand level on the basis of the preference information of spectators in each seating block and product purchase histories of spectators in each seating block.

(5) The route determination apparatus described in any one of (1) to (3) above,

wherein the determining includes:
generating a demand level map indicating a distribution of demand levels calculated for each seating block; and
determining, in the generated demand level map, a route that passes close to a seating block in which a demand level satisfies a predetermined criterion.

(6) The route determination apparatus described in any one of (1) to (3) above,

wherein the adjusting includes
adjusting the route of each vendor such that the number of vendors present at the same time in a same cell formed by a base station installed in the facility is less than a predetermined number.

A route determination method including:
collecting preference information relating to preferences of spectators at an event held at a facility;
calculating, from the collected preference information, a demand level for a vendor of products in each seating block in the facility;
determining, on the basis of the demand level in each seating block, routes along which the vendor is to move; and
adjusting the route such that a position of the vendor moving along the determined route satisfies a predetermined condition.

### REFERENCE SIGNS LIST

100 Route determination apparatus
101 Processor
102 Memory
103 Storage
104 Communicator
110 Communication I/F
120 Spectator information collector
130 Spectator information storer
140 Sales information management device
150 Game information acquirer
160 Demand level calculator
170 Map generator
180 Route determiner
190 Route adjuster

1. A route determination apparatus having one or more processors that execute a process comprising:
collecting preference information relating to preferences of spectators at an event held at a facility;
calculating, from the collected preference information, a demand level for a vendor of products in each seating block in the facility;
determining, on the basis of the demand level in each seating block, a route along which the vendor is to move; and
adjusting the route such that a position of the vendor moving along the determined route satisfies a predetermined condition.

2. The route determination apparatus according to claim 1,
wherein the collecting comprises
collecting information regarding a brand of a product that a spectator selects from among products sold in the facility.

3. The route determination apparatus according to claim 1,
wherein the collecting comprises
collecting information regarding a vendor that a spectator selects from among vendors selling products in the facility.

4. The route determination apparatus according to claim 1,
wherein the calculating comprises
calculating the demand level on the basis of the preference information of spectators in each seating block and product purchase histories of spectators in each seating block.

5. The route determination apparatus according to claim 1,
wherein the determining comprises:
generating a demand level map indicating a distribution of demand levels calculated for each seating block; and
determining, in the generated demand level map, a route that passes close to a seating block in which a demand level satisfies a predetermined criterion.

6. The route determination apparatus according to claim 1,
wherein the adjusting comprises
adjusting the route of each vendor such that the number of vendors present at the same time in a same cell formed by a base station installed in the facility is less than a predetermined number.

7. A route determination method comprising:
collecting preference information relating to preferences of spectators at an event held at a facility;
calculating, from the collected preference information, a demand level for a vendor of products in each seating block in the facility;
determining, on the basis of the demand level in each seating block, a route along which the vendor is to move; and
adjusting the route such that a position of the vendor moving along the determined route satisfies a predetermined condition.
